(19) United States
(12) Patent Application Publication
(10) Pub. No.: US 2004/0000591 A1
(43) Pub. Date: Jan. 1, 2004

(54) Checkout device including integrated barcode reader and EAS system

(76) Inventors: Donald A. Collins JR., Atlanta, GA (US); Steven J. Hammer, Lilburn, GA (US)

Correspondence Address: PAUL W. MARTIN, LAW DEPARTMENT, WHQ-5E, 1700 S. PATTERSON BLVD., DAYTON, OH, 45479-0001, US

(21) Appl. No.: 10/185,302

(22) Filed: Jun. 28, 2002

(51) Int. Cl. G06K 7/10

(52) U.S. Cl. 235/462.14

(57) ABSTRACT

A checkout device with a barcode reader and electronic article surveillance (EAS) system. The checkout device includes a barcode reader including a first portion having a substantially horizontal aperture and a second portion having a substantially vertical aperture, a weight plate suspended above the horizontal portion, and a security label deactivation system between the first portion and the weigh plate.

### CROSS-REFERENCE TO RELATED APPLICATIONS

The present invention is related to the following commonly assigned co-pending U.S. applications filed therewith:

application Ser. No. 10/061,381, entitled “CHECKOUT DEVICE INCLUDING INTEGRATED BARCODE READER, SCALE AND EAS SYSTEM”, having as inventors, Donald A. Collins, et al., filed Feb. 1, 2002.

### BACKGROUND OF THE INVENTION

The present invention relates to product checkout devices and more specifically to a checkout device including an integrated barcode reader and electronic article surveillance (EAS) system.

Common checkout devices include barcode readers or combinations of barcode readers and scales. One example of a checkout device is the NCR 7875 checkout device.

Another example of a checkout device includes a barcode reader and an integrated EAS system and is illustrated in U.S. Pat. No. 5,059,951.

It would be desirable to produce a checkout device with an integrated barcode reader and EAS system. It would also be desirable to provide a checkout device with an integrated barcode reader, scale, and EAS system.

### SUMMARY OF THE INVENTION

In accordance with the teachings of the present invention, a checkout device including an integrated barcode reader and electronic article surveillance (EAS) is provided.

The checkout device includes a barcode reader including a first portion having a substantially horizontal aperture and a second portion having a substantially vertical aperture, a weight plate suspended above the horizontal portion, and a security label deactivation system between the first portion and the weigh plate.

A checkout method includes the steps of reading a barcode label on an item moving in a path, which crosses an aperture of a scale weigh plate by a barcode reader, sending a signal to an interlock by the barcode reader, enabling a security label deactivation system between the scale weigh plate and a first portion of the barcode reader and in a downstream position from the aperture relative to the path of the item, detecting a security label on the item by the security label deactivation system as the item moves along the path and crosses the security label deactivation system, and deactivating the security label by the security label deactivation system.

It is accordingly an object of the present invention to provide a checkout device including a barcode reader and an electronic article surveillance (EAS) system.

It is another object of the present invention to provide a method of integrating a barcode reader and an EAS system into a single checkout device.

It is another object of the present invention to provide a method of integrating a barcode reader, scale, and an EAS system into a single checkout device.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a checkout system;

FIG. 2 is a perspective view of a checkout device; and

FIG. 3 is a perspective view of the checkout device with scale weigh plate removed.

### DETAILED DESCRIPTION OF THE PREFERRED EMBODIMENT

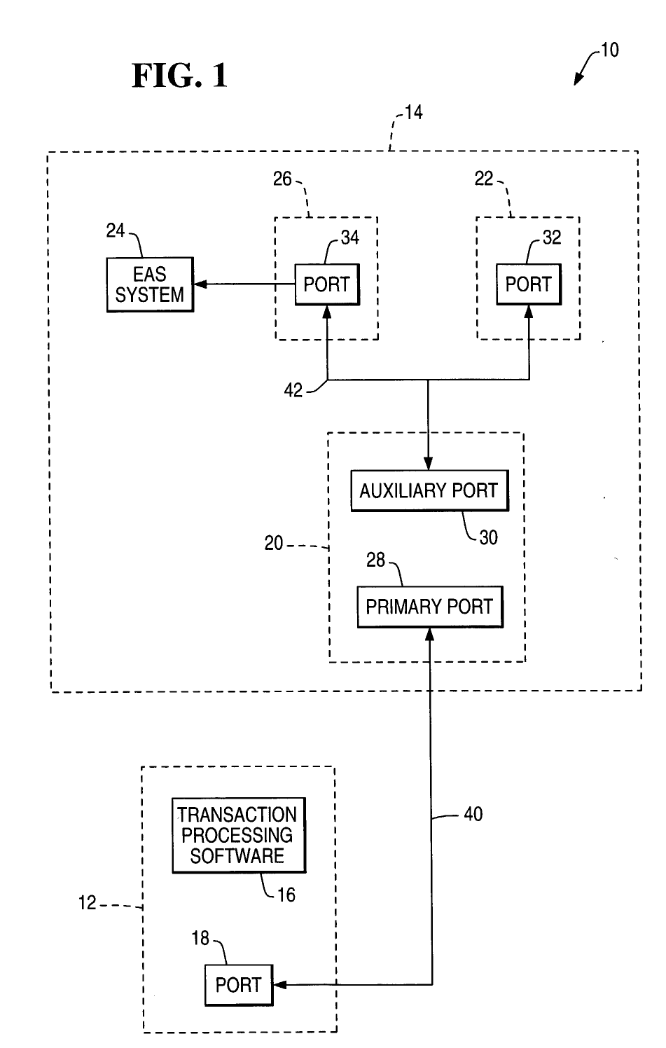

Referring now to FIG. 1, checkout system 10 includes point-of-sale (POS) terminal 12 and checkout device 14.

POS terminal 12 executes transaction processing software 16, which records items for purchase and records payment for the items.

POS terminal 12 additionally includes port 18 to which checkout device 14 is connected. Port 18 may be a serial port, such as an RS232 serial port.

Checkout device 14 primarily includes barcode reader 20 and electronic article surveillance (EAS) system 24. Checkout device 14 may additionally include scale 22.

Barcode reader 20 reads barcode labels on purchased items. Barcode reader 20 also sends an enable signal to EAS system 24 through interlock 26 following reading. Barcode reader 20 preferably includes primary port 28 for connection barcode reader 20 to port 18 of POS terminal 12. In addition, barcode reader 20 preferably includes auxiliary port 30 to which other peripherals, such as scale 22 are connected. Primary and auxiliary ports 28 and 30 may be serial ports, such as RS232 serial ports.

Barcode reader 20 may include an NCR model 7875 barcode reader. Barcode reader 20 may also include separately housed horizontal and vertical barcode readers.

Scale 22 weighs purchased produce items.

EAS system 24 deactivates security labels on purchased items that have them. EAS system 24 senses the presence of a security label and deactivates the security label. EAS system 24 may be connected to auxiliary port 30 or to interlock 26. If present, interlock 26 activates EAS system 24 in response to an enable system from barcode reader 20. Thus, interlock 26 signals EAS system 24 to detect a security label only if barcode reader 20 has read a barcode label.

POS terminal 12 and checkout device 14 may be coupled in various ways. In the illustrated example, cable 40 couples port 18 of POS terminal 12 to primary port 28 of barcode reader 20. Cable 42 couples auxiliary port 30 of barcode reader 20 to port 32 of scale 22 and port 34 of interlock 26.

Under this example, cables 40 and 42 supply data. Cable 42 may additionally supply power to scale 22 from barcode reader 20.

Multiple power connections supply power. POS terminal 12 and barcode reader 20 have their own power connections. Interlock 26 and EAS system 24 share another power connection.

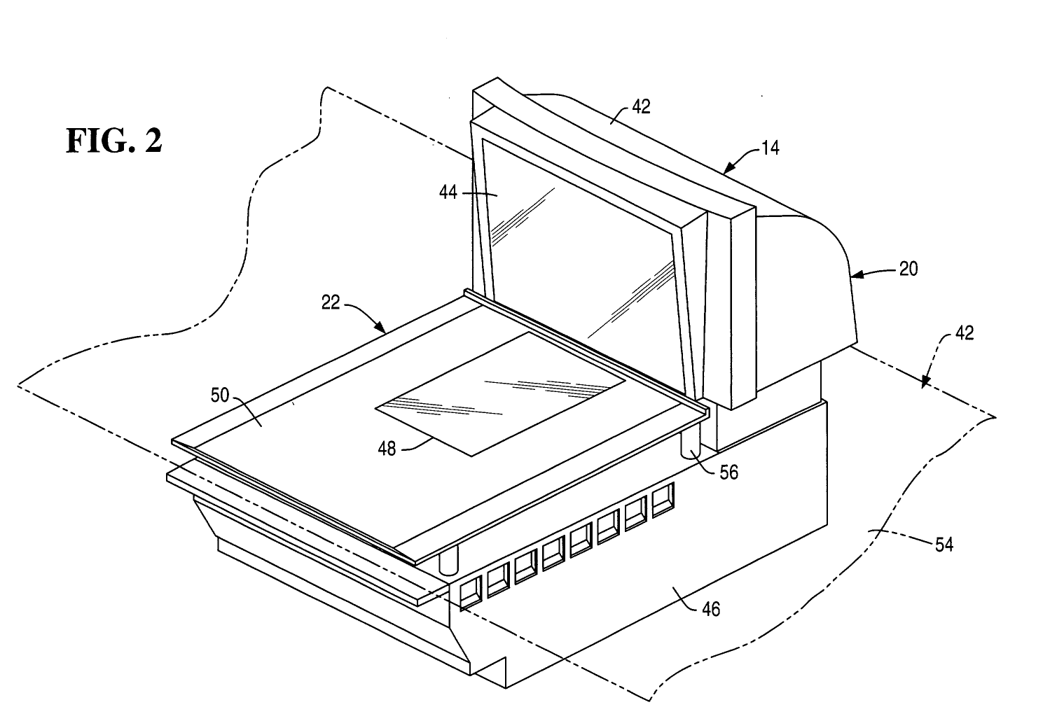

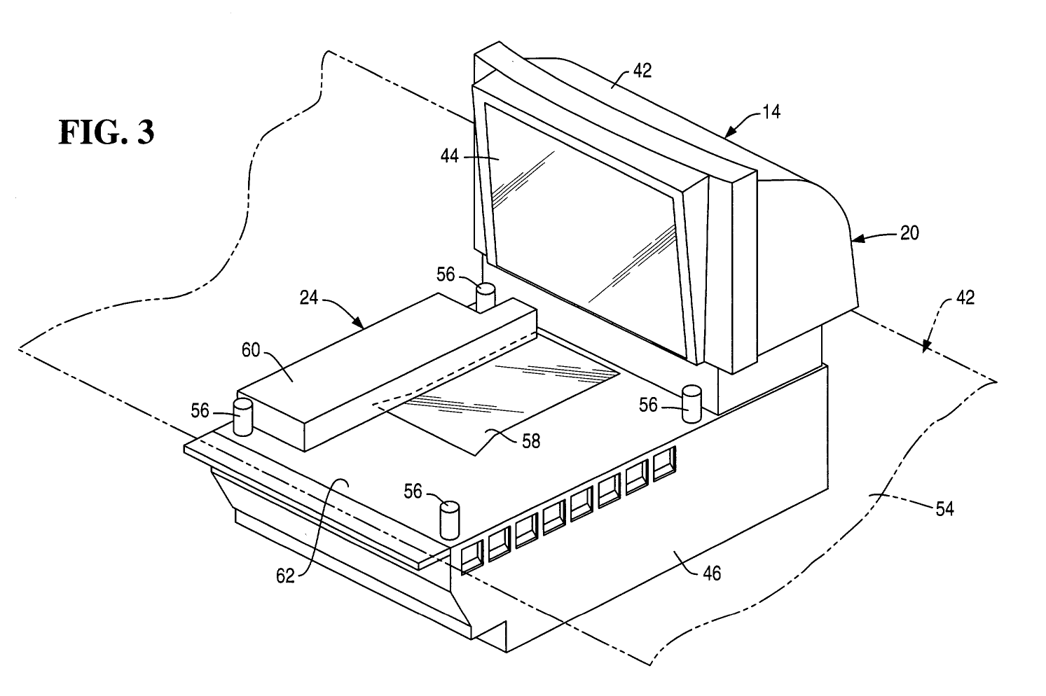

Turning now to FIGS. 2-3, checkout device 14 is shown in more detail.

Checkout device 14 includes housing portions 42 and 46. Housing portions 42 and 46 contain optical components for barcode reader 20. Housing portion 42 includes vertical aperture 44 through which scanning light beams pass.

Checkout device 14 is preferably about 11.5 inches in width by 20 inches in length so as to fit within a “standard” U.S. checkstand hole for combination barcode reader and scale assemblies.

Housing portion 46 includes a load cell assembly and weigh plate 50 of scale 22. Weigh plate 50 includes horizontal aperture 48 through which scanning light beams pass. Housing portion 46 is mounted within checkout counter 52 so that weigh plate 50 is substantially flush with top surface 54 of checkout counter 52.

With reference to FIG. 3, EAS system 24 is mounted on top surface 62 of housing portion 46. Posts 56 support weigh plate 50 above EAS system 24 so as to provide an additional space to locate EAS system 24. Checkout device 14 is about two inches deeper than the NCR model 7875 checkout device in order to accommodate installation of EAS system 24.

EAS system 24 may slightly overlap aperture 58 from one side of aperture 58 without substantially interfering with the operation of barcode reader 22. Aperture 58 is in line with aperture 48 of weigh plate 50.

An example EAS system 24 includes electromagnetic coil 60. Coil 60 may include separate sense and deactivation coils. Corresponding security labels on products preferably include magnetic material. Coil 60 is packaged into a generally rectangular three-dimensional shape.

Coil 60 is preferably oriented so that its length dimension is oriented perpendicular to the direction of product movement. In this way, security labels are exposed to the electromagnetic field from coil 60 after they are moved across aperture 48 of weigh plate 50.

The illustrated example shows EAS system 24 in a left side of housing portion 46 and left of horizontal aperture 58. The example is suitable for a right-to-left scanning motion. EAS system 24 may instead be located on a right side of housing portion 46 for left-to-right scanning.

In operation, a product bearing a barcode label and a product security label are moved across weigh plate 50. Barcode reader 20 reads the barcode label and sends an enable signal to interlock 26. Interlock 26 signals EAS system 24 to detect the product security label. Coil 60 senses the magnetic material in the security label. Coil 60 demagnetizes the magnetic material in the security label.

Although the invention has been described with particular reference to certain preferred embodiments thereof, variations and modifications of the present invention can be effected within the spirit and scope of the following claims.

What is claimed is:

1. A checkout device comprising:
a barcode reader including a first portion having a substantially horizontal aperture and a second portion having a substantially vertical aperture;
a weight plate suspended above the horizontal portion; and
a security label deactivation system between the first portion and the weigh plate.

2. A checkout device comprising:
a barcode reader including a first portion having a substantially horizontal aperture and a second portion having a substantially vertical aperture;
a weight plate suspended above the horizontal portion; and
a security label deactivation system adjacent the first portion and under the weigh plate.

3. A checkout device comprising:
a first barcode scanning portion for generating first scan lines that pass through a substantially horizontal aperture;
a second barcode scanning portion for generating second scan lines that pass through a substantially vertical aperture;
a weight plate suspended above the first barcode scanning portion; and
a security label deactivation system between the first barcode scanning portion and the weigh plate.

4. A checkout device comprising:
a barcode reader including a first portion having a substantially horizontal aperture and a second portion having a substantially vertical aperture;
a weight plate suspended above the horizontal portion; and
a security label deactivation system between the first portion and the weigh plate substantially to one side of the substantially horizontal aperture.

5. The checkout device as recited in claim 4, wherein the one side comprises a left side.

6. The checkout device as recited in claim 4, wherein the one side comprises a right side.

7. A checkout method comprising the steps of:
reading a barcode label on an item moving in a path, which crosses an aperture of a scale weigh plate by a barcode reader;
sending a signal to an interlock by the barcode reader;
enabling a security label deactivation system between the scale weigh plate and a first portion of the barcode reader and in a downstream position from the aperture relative to the path of the item;
detecting a security label on the item by the security label deactivation system as the item moves along the path and crosses the security label deactivation system; and
deactivating the security label by the security label deactivation system.

8. The method as recited in claim 7, wherein the detecting step comprises the substeps of:
sensing movement a magnetic material in the security label as it passes near a coil assembly in the security label deactivation system.

9. The method as recited in claim 7, wherein the detecting step comprises the substeps of:
demagnetizing a magnetic material in the security label as it passes near a coil assembly in the security label deactivation system.
